(19) United States
(12) Patent Application Publication
(10) Pub. No.: US 2008/0246412 A1
(43) Pub. Date: Oct. 9, 2008

(54) Fluorescent lamp driver

(75) Inventors: Dongping Yang, Shenzhen (CN); Chengcai Gui, Shenzhen (CN); Zhi Zhang, Shenzhen (CN)

Correspondence Address: DAVID AND RAYMOND PATENT FIRM, 108 N. YNEZ AVE., SUITE 128, MONTEREY PARK, CA, 91754, US

(73) Assignee: SHENZHEN MEGMEET ELECTRICAL TECHNOLOGY CO., LTD

(21) Appl. No.: 11/986,526

(22) Filed: Nov. 20, 2007

(30) Foreign Application Priority Data
Apr. 5, 2007 (CN) 200710073922.5

(51) Int. Cl. H05B 41/24

(52) U.S. Cl. 315/247

(57) ABSTRACT

The present invention discloses a kind of fluorescent lamp driver, which consists of the multi-switch converting circuit, power transformer (T1), resonant inductor (L1), resonant capacitor (C3) and step-up transformer (T2). It features the followings: The primary winding (PW) of T1 connects with the AC output of multi-switch converting circuit. L1 and C3, after series connection, connect with the secondary winding (SW) of T1 through the PW of T2. The SW of T2 connects with the load output. In this invention, a resonant inductor is connected in series on the resonant loop to realize frequency and voltage modulation as well as the soft switch function of the primary power switch of the power transformer.

### BACKGROUND OF THE PRESENT INVENTION

1. Field of Invention

This invention relates to the electrical field, in particularly to a type of fluorescent lamp driver.

2. Description of Related Arts

A Liquid Crystal Display (LCD) device generally consists of a backlight module and a liquid crystal panel. The backlight module is used to provide light source for the liquid crystal panel that does not give out light at all, but power supply is required for both of them.

In present application, the fluorescent lamp driver as shown in FIG. 1 consists of the PFC circuit, T1, T2, switch 1 (S1), switch 2 (S2), switch 3 (S3) and switch 4 (S4). S1 and S2, after series connection, connect in parallel at the input end Vin. One end of C2 connects with the midpoint of S1 and S2, and the other end connects with the midpoint of S3 and S4 through the PW of T1. The PW of T1 connects with the AC output of the multi-switch converting circuit. The SW of T2 connects with the load output. The SW of T1 connects with the PW of T2. The leakage inductor of the PW of T2 and the C2 form an oscillating circuit, providing AC power for load.

FIG. 2 shows the frequency relation between the present voltage and the excitation power. The more step-up transformers are connected in parallel, the less the equivalent inductance Lr=Lr′/n (where, n refers to the number of step-up transformers; Lr′ refers to the leakage inductance converted to the PW) converted to the resonant loop. When the resonant inductance is too small, the value of Q is low and f1 goes up to f2, the voltage Δv of Rlamp shows a small change, which falls short of the requirement for adjusting load voltage range.

The disadvantages of current technology:

When several step-up transformers are connected in parallel to drive the load, the equivalent leakage inductance of SW of the step-up transformers greatly decreases. The oscillation is unavailable and the load voltage cannot be adjusted through the frequency modulation because of the small inductance of the oscillator loop formed with C2, and the low value of Q.

The soft switch function of the primary power switch also cannot be realized at specified working frequency due to the small inductance and high resonant frequency.

### SUMMARY OF THE PRESENT INVENTION

The technical issue to be addressed in this invention is to provide a type of fluorescent lamp driver that could realize normal frequency and voltage modulation even after the parallel connection with multiple step-up transformers, and realize the soft switch function of the primary power switch of the power transformer.

The following solution is adopted to address the above technical issue.

The present invention discloses a kind of fluorescent lamp driver, which consists of the multi-switch converting circuit, T1, L1, C3 and T2. It features the following:

The PW of T1 connects with the AC output of multi-switch converting circuit.

L1 and C3, after series connection, connect with the SW of T1 through the PW of T2.

The SW of T2 connects with the load output.

Wherein, the blocking capacitor (C2) is included, and C2 connects with the PW of T1 and the output of multi-switch converting circuit.

Wherein, the multi-switch converting circuit is a half-bridge topology circuit.

Wherein, the multi-switch converting circuit is a full-bridge topology circuit.

Wherein, the PFC circuit is included, and it outputs high-voltage DC to the input of the multi-switch converting circuit.

Wherein, at least two step-up transformers are included; the PWs of every step-up transformer are connected in parallel; the SWs of every step-up transformer connect with the load output respectively.

It can be seen from the above solution that this invention increases the inductance of the resonant loop, improves the value of Q and lowers the resonant frequency through the series connection of a resonant inductor on the resonant loop. Therefore, this solution realizes the following functions:

The primary load voltage of the step-up transformer can be adjusted through the frequency modulation of the primary switching circuit.

The soft switch function of the primary power switch is realized.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 shows a schematic diagram of existing LCD power circuit.

FIG. 2 shows a diagram of frequency relation between present voltage and excitation power.

FIG. 3 shows a schematic diagram of the power circuit of the invention.

FIG. 4 shows a schematic diagram of the first embodiment of the invention.

FIG. 5 shows a schematic diagram of the second embodiment of the invention.

FIG. 6 shows a schematic diagram of the third embodiment of the invention.

FIG. 7 shows an equivalent circuit diagram for the circuit in FIG. 5.

FIG. 8 shows a diagram of frequency relation between the voltage and excitation power supply of the lamp.

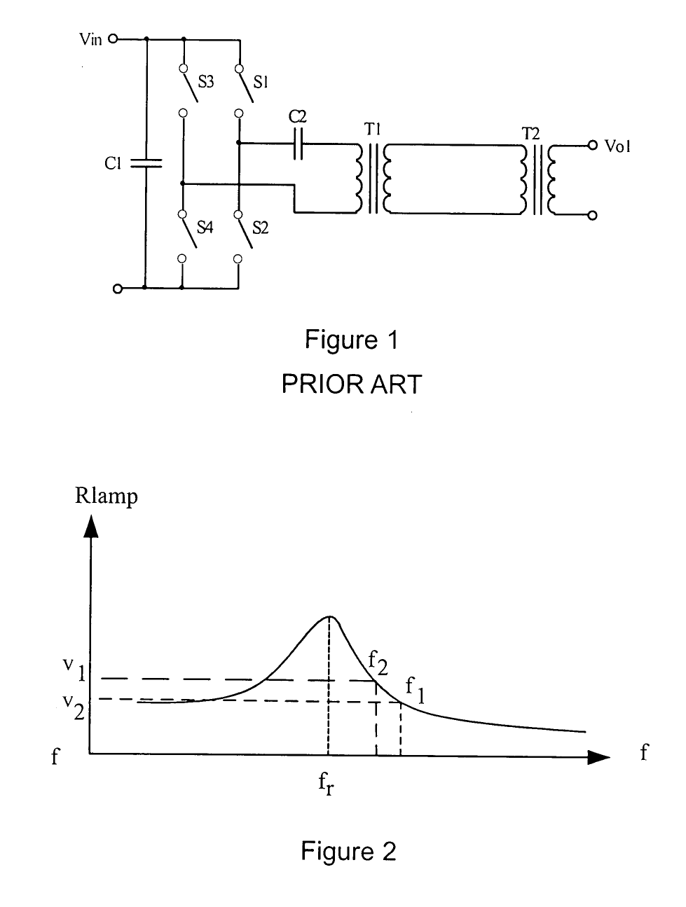

### DETAILED DESCRIPTION OF THE PREFERRED EMBODIMENT

In the following detailed description of embodiments of the invention, numerous specific details are set forth in order to provide a more thorough understanding of the invention with reference to the accompanying figures.

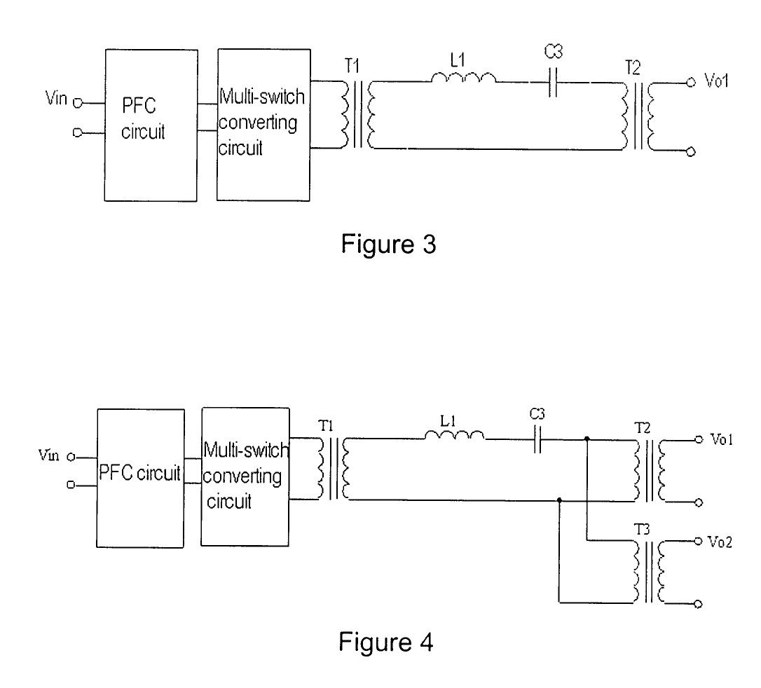

FIG. 3 shows a schematic diagram of the power circuit of the invention. This circuit includes the PFC circuit, multi-switch converting circuit in connection with the high-voltage DC output of the PFC circuit, power transformer (T1), step-up transformer (T2), rectifier, resonant inductor (L1) and resonant capacitor (C3).

The PW of T1 connects with the AC output of the multi-switch converting circuit, and the SW of T1 connects with the PW of T2 through L1 and C3. The SW of T2 connects with the load output.

Similar to FIG. 3, FIG. 4 shows a schematic diagram of the first embodiment of the invention, with the differences as follows:
At least two step-up transformers are included.
The PWs of every step-up transformer are connected in parallel.
The SWs of every step-up transformer connect with the load output respectively.

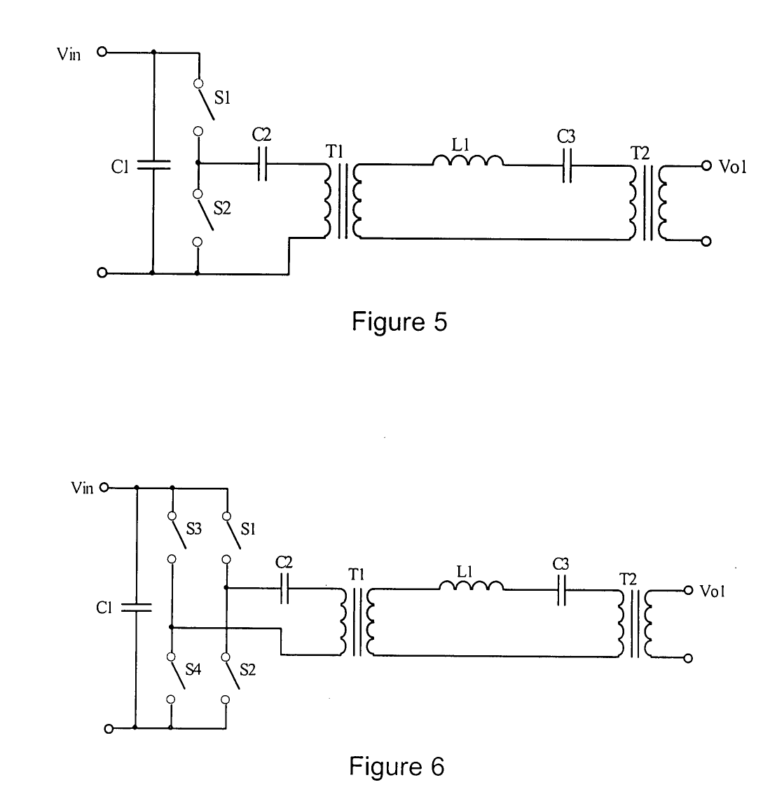

The multi-switch circuit may adopt a full-bridge or half-bridge circuit topology. The following describes the half-bridge circuit topology. FIG. 5 shows a schematic diagram of the second embodiment of the invention. The multi-switch circuit adopts a half-bridge circuit topology, which includes the PFC circuit, multiple-switch converting circuit in connection with the high-voltage DC output of the PFC circuit, T1, T2, rectifier, L1, C3 and C2.

The multiple-switch converting circuit includes S1 and S2. S1 and S2, after series connection, connect with each other in parallel at the input end Vin. One end of C2 connects with the midpoint of S1 and S2, and the other end connects with the Vin through the PW of T1.

L1 and C3, after series connection, connect with the SW of T1 through the PW of T2. The SW of T2 connects with the load output.

FIG. 6 is similar to the schematic diagram of the second and third embodiment, with the differences as follows: The multi-switch circuit adopts a full-bridge circuit topology, which includes the PFC circuit, multiple-switch converting circuit in connection with the PFC circuit high-voltage DC output, T1, T2, rectifier, L1, C3 and C2.

The multi-switch converting circuit includes S1, S2, S3 and S4. S1 and S2, after series connection, connect in parallel at the input end Vin. S3 and S4, after series connection, connect in parallel at the input end Vin. One end of C2 connects with the midpoint of S1 and S2, and the other end connects with the midpoint of S3 and S4 through the PW of T1. This embodiment mode features all the advantages of the first embodiment.

The operational principle of other embodiments is similar to that of FIG. 5, a typical embodiment in this invention. Therefore, the following takes FIG. 5 as an example to illustrate the operational principle of this invention.

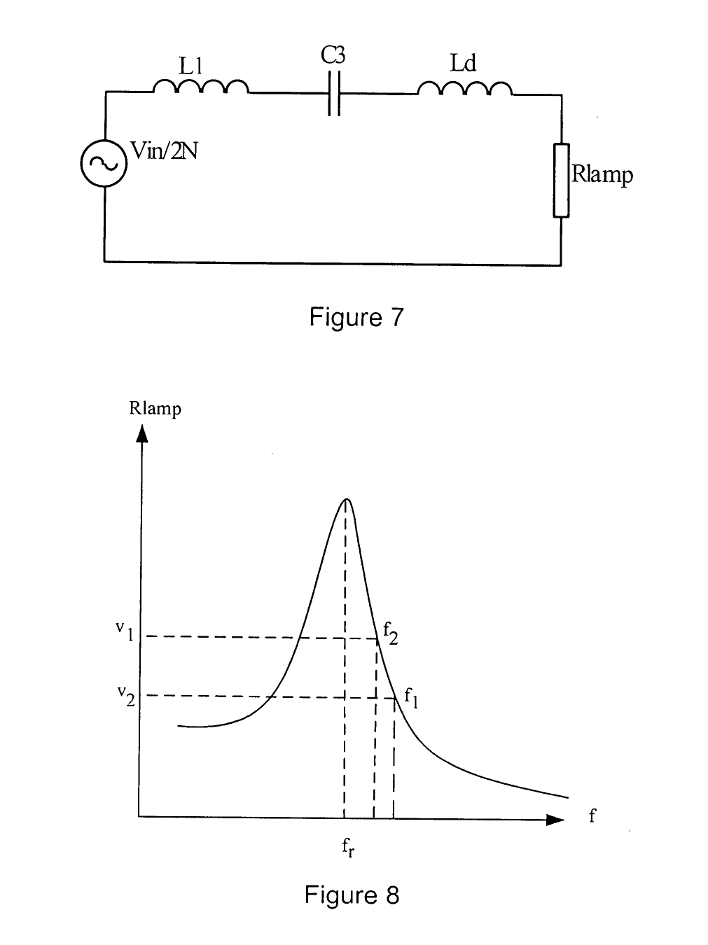

FIG. 7 shows an equivalent circuit diagram for the circuit in FIG. 5. If the equivalent leakage inductance of T2 in FIG. 5 is Ld, then the resonant frequency of the circuit fr is:

fr=1/2π\sqrt{C3(L1+Ld)}

FIG. 8 shows the frequency relation between the voltage of lamp load Rlamp and excitation power Vin/2N. When f1 goes up to f2, the voltage of Rlamp increases. Therefore, the luminosity of the lamp can be changed by adjusting the frequency. When adjusting the frequency, select a working frequency higher than the resonant frequency fr so that the power switch of the half-bridge circuit shown in FIG. 5 works in the zero-voltage switching state, lowering the switching loss of the power switch and realizing the soft switch function for the primary power switch.

The above details a type of fluorescent lamp driver presented in this invention. This document elaborates on the operational principle and embodiments of the invention with reference to a specific embodiment. The above embodiments are only used to help understand the methods and core concept of this invention. Various modifications and applications will readily occur to those skilled in the art and may be employed, as suitable, without departing from the true spirit of the invention. Therefore, it is to be understood that the contents in this document shall by no means be construed as a limitation of this invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fluorescent lamp driver, which comprises a multi-switch converting circuit, a power transformer (T1), a resonant inductor (L1), a resonant capacitor (C3) and a step-up transformer (T2), comprising:
a primary winding (PW) of the power transformer T1 which connects with an AC output of the multi-switch converting circuit;
wherein L1 and C3, after series connection, connect with a secondary winding (SW) of T1 through the PW of the T2; and
a SW of T2 connects with the load output.

2. The fluorescent lamp driver as set forth in claim 1, wherein a blocking capacitor (C2) is included and C2 and the PW of T1 connects with the output of multi-switch converting circuit.

3. The fluorescent lamp driver as set forth in claim 1, wherein the multi-switch converting circuit is a half-bridge topology circuit.

4. The fluorescent lamp driver as set forth in claim 2, wherein the multi-switch converting circuit is a half-bridge topology circuit.

5. The fluorescent lamp driver as set forth in claim 1, wherein the multi-switch converting circuit is a full-bridge topology circuit.

6. The fluorescent lamp driver as set forth in claim 2, wherein the multi-switch converting circuit is a full-bridge topology circuit.

7. The fluorescent lamp driver as set forth in claim 1, wherein the Powel Factor Correction (PFC) circuit is included, and it outputs high-voltage DC to the input of the multi-switch converting circuit.

8. The fluorescent lamp driver as set forth in claim 2, wherein the Power Factor Correction (PFC) circuit is included, and it outputs high-voltage DC to the input of the multi-switch converting circuit.

9. The fluorescent lamp driver as set forth in claim 3, wherein the Power Factor Correction (PFC) circuit is included, and it outputs high-voltage DC to the input of the multi-switch converting circuit.

10. The fluorescent lamp driver as set forth in claim 4, wherein the Power Factor Correction (PFC) circuit is included, and it outputs high-voltage DC to the input of the multi-switch converting circuit.

11. The fluorescent lamp driver as set forth in claim 5, wherein the Power Factor Correction (PFC) circuit is included, and it outputs high-voltage DC to the input of the multi-switch converting circuit.

12. The fluorescent lamp driver as set forth in claim 6, wherein the Power Factor Correction (PFC) circuit is included, and it outputs high-voltage DC to the input of the multi-switch converting circuit.

13. The fluorescent lamp driver as set forth in claim 1, comprising at least two step-up transformers, wherein the PWs of every said step-up transformer are connected in parallel, and the SWs of every said step-up transformer are connected with the load output respectively.

14. The fluorescent lamp driver as set forth in claim 2, comprising at least two step-up transformers, wherein the PWs of every said step-up transformer are connected in parallel, and the SWs of every said step-up transformer are connected with the load output respectively.

15. The fluorescent lamp driver as set forth in claim 3, comprising at least two step-up transformers, wherein the PWs of every said step-up transformer are connected in parallel, and the SWs of every said step-up transformer are connected with the load output respectively.

16. The fluorescent lamp driver as set forth in claim 4, comprising at least two step-up transformers, wherein the PWs of every said step-up transformer are connected in parallel, and the SWs of every said step-up transformer are connected with the load output respectively.

17. The fluorescent lamp driver as set forth in claim 5, comprising at least two step-up transformers, wherein the PWs of every said step-up transformer are connected in parallel, and the SWs of every said step-up transformer are connected with the load output respectively.

18. The fluorescent lamp driver as set forth in claim 6, comprising at least two step-up transformers, wherein the PWs of every said step-up transformer are connected in parallel, and the SWs of every said step-up transformer are connected with the load output respectively.

19. The fluorescent lamp driver as set forth in claim 10, comprising at least two step-up transformers, wherein the PWs of every said step-up transformer are connected in parallel, and the SWs of every said step-up transformer are connected with the load output respectively.

20. The fluorescent lamp driver as set forth in claim 12, comprising at least two step-up transformers, wherein the PWs of every said step-up transformer are connected in parallel, and the SWs of every said step-up transformer are connected with the load output respectively.
